(19) United States
(12) Patent Application Publication
(10) Pub. No.: US 2009/0018003 A1
(43) Pub. Date: Jan. 15, 2009

(54) ROLLING PIN

(76) Inventors: LYNN VENDL, Woodridge, IL (US); Louis Henry, New York, NY (US); Melanie Conklin, Brooklyn, NY (US); Charlie Paradise, New York, NY (US)

Correspondence Address: PATENT GROUP;C/O DLA PIPER US LLP, 203 N. LASALLE ST., SUITE 1900, CHICAGO, IL, 60601, US

(21) Appl. No.: 12/132,250

(22) Filed: Jun. 3, 2008

Related U.S. Application Data
(60) Provisional application No. 60/959,061, filed on Jul. 11, 2007.

(51) Int. Cl. A21C 3/02

(52) U.S. Cl. 492/14

(57) ABSTRACT

Rolling pins of the present invention generally have a core, a rolling surface disposed on the outer surface of the core, a shaft that extends through the core, a first handle, and a second handle. The shaft has a first handle section, a second handle section, and a central section, and also has a shaft length greater than the core length. The handles are removably connected to the handle sections of the shaft. Preferably, the handle sections of the rolling pin shaft have locking features, and the handles have catches that releasably engage the locking features. The rolling surface is made from, or contains, thermoplastic elastomer. In at least some embodiments, the rolling surface can be a sleeve that slides onto the outer surface of the core and is secured to the ends of the core by end caps.

### RELATED APPLICATIONS

This application claims the benefit of U.S. Provisional Patent Application Ser. No. 60/959,061, filed on Jul. 11, 2007, currently pending. The disclosure of which is hereby incorporated by reference in its entirety.

### BACKGROUND

The present invention relates generally to kitchen utensils, and more particularly to a rolling pin.

Rolling pins are food preparation utensils generally used to shape and flatten dough prior to cooking or baking, such as when pastries or other baked goods are made. For example, rolling pins can be used with various types of dough, from pastry dough to self-rising and yeast dough, for use in making products such as pie crusts, biscuits, cookies, and other pastry and bread products. Typically, dough tends to stick to the rolling surface of a rolling pin, as well as to the base surface on which the dough is being rolled. Traditionally, flour is used to reduce or prevent the dough from sticking. To this end, flour can be added to any or all of the base surface, the bottom or top surface of the dough, and the rolling surface of the rolling pin. The addition of flour, however, tends to change the texture of the dough, and too much additional flour can render the dough unsuitable for its intended purpose.

Rolling pins typically have a rotating cylindrical rolling surface with handles at each end. Such rolling pins are often referred to as “roller style” rolling pins. Cleaning of the rolling surface of such a rolling pin increases in difficulty if the handles of the rolling pin must be washed with the rolling surface. In addition, it is undesirable to have water entering the interior of a rolling pin during cleaning. As a result, many prior art rolling pins should not be submersed in water during cleaning. A need therefore exists for a rolling pin having removable handles and a sealed interior, so as to be submersible in water, for ease of cleaning of the rolling pin.

### BRIEF SUMMARY

The present invention relates to rolling pins, and more particularly to roller style rolling pins.

Rolling pins of the present invention generally have a core, a rolling surface disposed on the outer surface of the core, a shaft that extends through the core, a first handle, and a second handle. The core preferably has an outer surface, an interior, a first end, a second end, and a core length extending from the first end to the second end. The shaft has a first handle section, a second handle section, and a central section, and also has a shaft length greater than the core length. The first handle is removably connected to the first handle section of the shaft, and the second handle removably connected to the second handle section of the shaft.

The rolling surface preferably is made from or contains thermoplastic elastomer. In at least some embodiments, the rolling surface can be a sleeve that slides onto the outer surface of the core. The sleeve has a first sleeve end and a second sleeve end, and preferably has a sleeve length greater than the core length. In such embodiments, the rolling pin preferably also has a first end cap securing the first sleeve end to the first end of the core, and a second end cap securing the second sleeve end to the second end of the core.

In preferred embodiments, the handle sections of the rolling pin shaft have locking features. In some such embodiments, shaft has a first handle section having a first locking feature, a second handle section having a second locking feature, and a central section. Correspondingly, the first handle has a first catch that releasably engages the first locking feature, and the second handle has a second catch that releasably engages the second locking feature.

### BRIEF DESCRIPTION OF SEVERAL VIEWS OF THE DRAWINGS

FIG. 1 is a perspective view of one embodiment of a rolling pin of the present invention.

FIG. 2 is a perspective view of the rolling pin of FIG. 1 with the handles detached from the shaft.

FIG. 3 is a detail cross section view taken along line A of FIG. 1.

### DETAILED DESCRIPTION

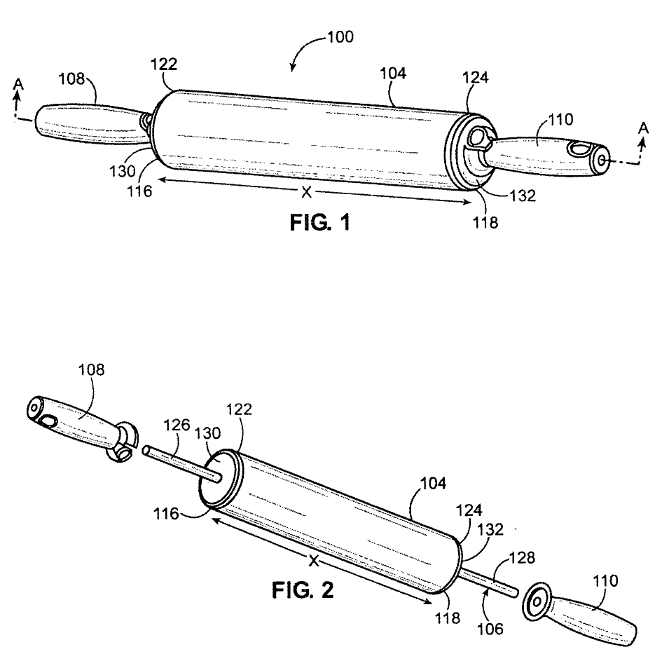

In FIGS. 1 and 2, a preferred embodiment of a rolling pin of the present invention is indicated in general at 100. As illustrated in FIG. 1, rolling pin 100 has a rolling surface 104, a first handle 108, and a second handle 110.

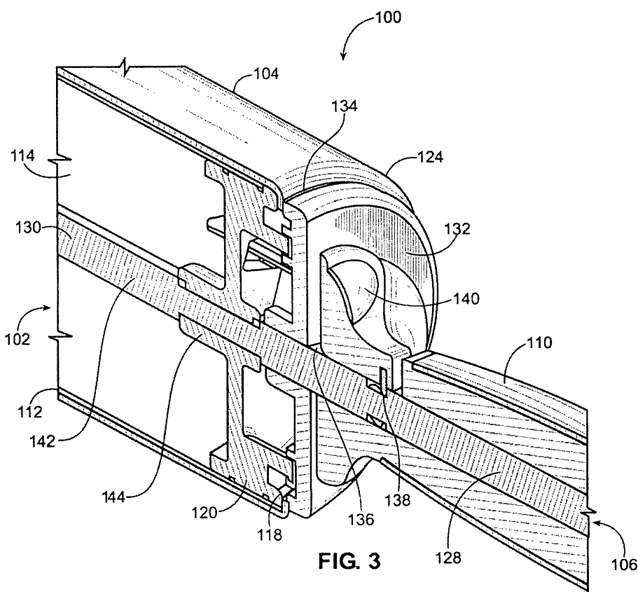

As illustrated in FIG. 3, the core 102 has an outer surface 112 and an interior 114. As illustrated in FIG. 2, the core also features a first end 116, a second end 118, and a core length X extending from the first end 116 to the second end 118. The core 102 is preferably rigid, and can be solid or hollow. In embodiments where the core is hollow, such as the embodiment illustrated in FIGS. 1-3, the core preferably also has a first interior support (not illustrated) at the first end 116 and a second interior support 120 at the second end 118. The outer surface 112 of the core 102 is most preferably cylindrical, but can be tapered towards one of the ends or towards both ends. The core can be made from any suitable material, including but not limited to wood, plastic, or metal.

As illustrated in FIG. 3, rolling surface 104 is disposed on the outer surface 112 of the core 102. As illustrated in FIG. 2, rolling surface 104 preferably covers at least the outer surface 112 along the core length X.

Rolling surface 104 is made from, contains, or consists essentially of, a thermoplastic elastomer. Thermoplastic elastomers are often abbreviated as TPE. Thermoplastic elastomers are generally copolymers or mixtures of polymers that consist of materials with both thermoplastic and elastomeric properties. Types of thermoplastic elastomers include, for example, styrenic block copolymers, polyolefin blends, elastomeric alloys, thermoplastic polyurethanes, thermoplastic copolyester and thermoplastic polyamides.

Rolling surface 104 can be made in a number of alternative suitable manners. For example, with reference to FIG. 3, the rolling surface 104 can be a separate element, such as a sleeve, that is formed and then mounted onto the exterior surface 112 of the core 102. A sleeve for use as rolling surface 104 can be molded, removed from the mold and then applied to the core 102. Depending upon the method of manufacture, it may be desirable lo turn a molded sleeve inside out alter it is removed from the mold, before applying it to the core 102, to ensure that there are no mold marks present on the exterior of the rolling surface 104.

In other embodiments, rolling surface 104 is not a separately formed element. Instead, rolling surface 104 can be formed directly on the exterior surface 112 of the core 102, such as by brushing, spraying, or molding.

With reference to FIG. 3, in order to ensure that the sleeve fits snugly onto the outer surface 112 of the core, the sleeve preferably has an internal diameter that is equal to or slightly greater than the diameter of the outer surface 112 of the core 102. As illustrated in FIGS. 1-3, the sleeve has a first sleeve end 122 and a second sleeve end 124. Preferably, the sleeve has a sleeve length greater than the core length X, and is positioned on the rolling pin 100 so that first sleeve end 122 extends beyond the first end 116 of the core 102 and second sleeve end 124 extends beyond the second end 118 of the core 102. The first sleeve end 122 and the second sleeve end 124 are then preferably bent or folded inwardly over the first end 116 and the second end 118 of the core, respectively. In this manner, the first and second sleeve ends each wrap around or cover at least a portion of an end of the core 102, such as an outer edge of the first or second core ends 116 and 118.

As illustrated in FIGS. 1-3, the rolling pin 100 has a first end cap 130 and a second end cap 132. First end cap 130 secures the first sleeve end 122 to the first end 116 of the core 102. Similarly, second end cap 132 secures the second sleeve end 124 to the second end 118 of the core 102. The first and second sleeve ends can be mounted on or attached to the core through the use of other devices, such as adhesive or fasteners, in addition to the end caps. The end caps 130 and 132 are preferably round, and have a diameter that is equal to or less than the diameter of the outer surface 112 of the core 102. The first end cap 130 and the second end cap 132 each form a seal with the sleeve, such seals preferably being watertight. For example, seal 134 between second end cap 132 and the sleeve is shown in FIG. 3. Additionally, the first end cap 130 and the second end cap 132 each form a seal with the shaft 106, such seals preferably also being watertight. For example, seal 136 between second end cap 132 and the shaft 106 is shown in FIG. 3.

The end caps form a seal with both the shaft 106 and the sleeve that forms rolling surface 104. The seals assist in preventing moisture or other foreign material from getting into the rolling pin.

As best illustrated in FIGS. 2 and 3, the shaft 106 has a shaft length greater than the core length X and, extends through the core 102. In order to ensure proper balance of the rolling pin 100, the shaft preferably passes through the center of the core 102. The shaft 106 has a first handle section 126, a second handle section 128, and a central section 142. The shaft 106 is preferably positioned so that the first handle section 126 of the shaft 106 extends beyond the first end 116 of the core 102, central section 142 of the shaft 106 passes through the core 102, and second handle section 128 of the shaft 106 extends beyond the second end 118 of the core 102. In embodiments where the core is hollow, central section 142 of the shaft 106 preferably also passes through any interior supports within the core. For example, as illustrated in FIG. 3, the shaft 106 extends through a shaft receiver 144 located at the center of interior support 120.

Shaft 106 preferably rotates with respect to the first handle 108 and the second handle 110, but not with respect to the core 102. In this manner, the core 102 and the rolling surface 104 can rotate as the rolling surface 104 is rolled over dough, but there is not any concurrent rotation of the handles 108 and 110. This arrangement helps to ensure that the rolling pin is sealed so that moisture or other foreign materials do not enter the interior 114 of the core 102. Additionally, rolling pin can be made such that the handles are at angles relative to the work surface without affecting the rotation of the core 102.

In an alternative embodiment, the rolling pin 100 can have a first shaft and a second shaft, where each shaft has a first end located within the core 102, and has a handle section that extends beyond one end of the core 102. In such embodiments, each shaft preferably rotates with respect to the first handle 108 and the second handle 110, but not with respect to the core 102.

The handles 108 and I 10 can be removed from rolling pin 102, as shown in FIGS. 2 and 3. More specifically, first handle 108 is preferably removably connected to the first handle section 126 of the shaft 106, and the second handle 110 is preferably removably connected to the second handle section 128 of the shaft 106. The connection between the handles and the shaft is preferably a rotatable lock and catch type mechanism, for example, the rolling pin 100 illustrated in FIGS. 1-3 has a first locking feature on the first handle section 126 of the shaft 106, and a second locking feature on the second handle section 128 of the shaft 106. The first locking feature and the second locking feature can each be, for example, a groove, a notch, an indentation, a rim, a bump or a protrusion. Correspondingly, there is a catch on the first handle 108 that releasably engages the first locking feature, and a catch on the second handle 110 that releasably engages the second locking feature.

One particularly preferred rotatable lock and catch type mechanism is illustrated in FIG. 3. Specifically, the second handle section 128 of shaft 106 has a locking feature 138, which is a groove around the circumference of the shall 106. Second handle 110 has a catch 140 that releasably engages locking feature 138. The catch 140 is a lever type clip, such that when the base of the clip is pressed inwards, towards the end cap, the clip detaches from the groove on shaft 106. The handle 110 can then be pulled outwardly, away from the end cap 132, and can thus be removed from the rolling pin 100. When the second handle 110 is connected to the shaft 106, the catch 140 remains engaged with locking feature 138 as the shaft 106 rotates within the second handle 110.

From the foregoing, it will be appreciated that although specific embodiments of the invention have been described herein for purposes of illustration, various modifications may be made without deviating from the spirit or scope of the invention. It is therefore intended that the foregoing detailed description be regarded as illustrative rather than limiting, and that it be understood that it is the following claims, including all equivalents, that are intended to particularly point out and distinctly claim the subject matter regarded as the invention.

What is claimed is:

1. A rolling pin comprising:
a core comprising an outer surface, an interior, a first end, a second end, and a core length extending from the first end to the second end;
a rolling surface disposed on the outer surface of the core, the rolling surface comprising thermoplastic elastomer;
a shall having a shaft length greater than the core length and extending through the core, the shaft comprising a first handle section, a second handle section, and a central section;
a first handle removably connected to the first handle section of the shaft; and
a second handle removably connected to the second handle section of the shaft.

2. The rolling pin of claim 1, wherein the shaft rotates with respect to the first and second handles.

3. The rolling pin of claim 1, further comprising:
a first locking feature on the first handle section of the shaft;
a second locking feature on the second handle section of the shaft;
a catch on the first handle that releasably engages the first locking feature; and
a catch on the second handle that releasably engages the second locking feature.

4. The rolling pin of claim 3, wherein the first locking feature and the second locking feature each comprises a groove, notch, indentation, rim, bump or protrusion.

5. The rolling pin of claim 1, wherein the rolling surface comprises a sleeve disposed on the outer surface of the core, the sleeve comprising a first sleeve end and a second sleeve end.

6. The rolling pin of claim 5, wherein the sleeve has a sleeve length greater than the core length, the rolling pin further comprising:
a first end cap securing the first sleeve end to the first end of the core: and
a second end cap securing the second sleeve end to the second end of the core.

7. The rolling pin of claim 6, wherein the first end cap and the second end cap each form a seal with the sleeve.

8. The rolling pin of claim 7, wherein the seal is watertight.

9. The rolling pin of claim 6, wherein the first end cap and the second end cap each form a seal with the shall.

10. The rolling pin of claim 9, wherein the seal is watertight.

11. A rolling pin comprising:
a core comprising an outer surface, an interior, a first end, a second end, and a core length extending from the first end to the second end;
a rolling surface disposed on the outer surface of the core, the rolling surface comprising a sleeve containing thermoplastic elastomer, the sleeve having a first sleeve end and a second sleeve end;
a shaft having a shaft length greater than the core length and extending through the core, the shaft comprising a first handle section, a second handle section, and a central section;
a first handle removably connected to the first handle section of the shaft; and
a second handle removably connected to the second handle section of the shaft.

12. The rolling pin of claim 11, wherein the sleeve has a sleeve length greater than the core length, the rolling pin further comprising:
a first end cap securing the first sleeve end to the first end of the core; and
a second end cap securing the second sleeve end to the second end of the core.

13. The rolling pin of claim 12, wherein the first end cap and the second end cap each form a seal with the sleeve.

14. The rolling pin of claim 12, wherein the first end cap and the second end cap each form a seal with the shaft.

15. The rolling pin of claim 12, the first end cap and the second end cap each form a seal with the sleeve and a seal with the shaft.

16. The rolling pin of claim 15, wherein each seal is a watertight seal.

17. A rolling pin comprising:
a core comprising an outer surface, an interior, a first end, a second end, and a core length extending from the first end to the second end;
a rolling surface disposed on the outer surface of the core, the rolling surface comprising thermoplastic elastomer;
a first shaft connected to the core, the first shaft comprising a first handle section that extends beyond the first end of the core;
a second shaft connected to the core, the second shaft comprising a second handle section that extends beyond the second end of the core;
a first handle removably connected to the first handle section; and
a second handle removably connected to the second handle section of the shaft.

18. The rolling pin of claim 17, wherein the first shaft rotates with respect to the first handle, and the second shaft rotates with respect to the second handle.

19. The rolling pin of claim 17, wherein the rolling surface comprises a sleeve disposed on the outer surface of the core, the sleeve comprising a first sleeve end and a second sleeve end.

20. The rolling pin of claim 19, wherein the sleeve has a sleeve length greater than the core length, the rolling pin further comprising:
a first end cap securing the first sleeve end to the first end of the core; and
a second end cap securing the second sleeve end to the second end of the core.
